(19) United States
(12) Patent Application Publication
(10) Pub. No.: US 2018/0093861 A1
(43) Pub. Date: Apr. 5, 2018

(54) ENHANCED ELEVATOR STATUS INFORMATION PROVISIONS FOR FIRE ALARM SYSTEMS

(71) Applicant: Otis Elevator Company, Farmington, CT (US)

(72) Inventors: Paul A. Stranieri, Bristol, CT (US); Ronnie E. Thebeau, Haddam, CT (US); James M. Collins, Burlington, CT (US); David M. Hughes, East Hampton, CT (US); Jannah A. Stanley, Portland, CT (US)

(21) Appl. No.: 15/281,445

(22) Filed: Sep. 30, 2016

(51) Int. Cl. B66B 5/02; B66B 5/00; B66B 1/28

(52) U.S. Cl. CPC B66B 5/024; B66B 1/28; B66B 5/0031

(57) ABSTRACT

A building elevator system including: a building having multiple floors; an elevator system within the building, the elevator system having an elevator car; a control system configured to control the elevator system, the control system determines an estimated time of arrival of the elevator car at a floor; and a fire alarm system within the building and in operative communication with the control system; wherein the control system transmits the estimated time of arrival of the elevator car to the fire alarm system.

### BACKGROUND

The subject matter disclosed herein relates generally to the field of elevator systems, and specifically to a method and apparatus for operating an elevator system in a building evacuation.

Commonly, during an evacuation procedure occupants of a building are instructed to take the stairs and avoid the elevator systems. An efficient method of incorporating the elevators into overall evacuation procedures is desired.

### BRIEF SUMMARY

According to one embodiment, a building elevator system is provided. The building elevator system including: a building having multiple floors; an elevator system within the building, the elevator system having an elevator car; a control system configured to control the elevator system, the control system determines an estimated time of arrival of the elevator car at a floor; and a fire alarm system within the building and in operative communication with the control system; wherein the control system transmits the estimated time of arrival of the elevator car to the fire alarm system.

In addition to one or more of the features described above, or as an alternative, further embodiments of the building elevator system may include that the fire alarm system further includes an interface device, wherein the control system transmits the estimated time of arrival of the elevator car to the interface device.

In addition to one or more of the features described above, or as an alternative, further embodiments of the building elevator system may include that the interface device is at least one of an operational interface of the fire alarm system and a user device.

In addition to one or more of the features described above, or as an alternative, further embodiments of the building elevator system may include that the control system transmits to the fire alarm system and the interface device an elevator car status including at least one of an elevator car location within the building, an elevator car load weight status, an elevator car door state, an elevator car direction of travel, and an elevator car speed.

In addition to one or more of the features described above, or as an alternative, further embodiments of the building elevator system may include that the fire alarm system transmits to the control system a fire alarm status including at least one of an active evacuation floor, a padding floor, a manual override, an evacuation zone evacuation command, and a total evacuation command.

In addition to one or more of the features described above, or as an alternative, further embodiments of the building elevator system may include that the estimated time of arrival of the elevator car is determined in response to at least one of an elevator car location within the building, an elevator car load weight status, an elevator car door state, an elevator car direction of travel, an elevator car speed, and an elevator destination floor.

In addition to one or more of the features described above, or as an alternative, further embodiments of the building elevator system may include a display located on each floor proximate the elevator system and in operative communication with the control system and fire alarm system, wherein the display is configured to display the estimated time of arrival of the elevator car at the floor where the display is located.

According to another embodiment, a method of operating a building elevator system for a building having multiple floors is provided. The method including: controlling, using a control system, an elevator system, the elevator system having an elevator car; detecting, using a fire alarm system, a fire within the building; determining, using the control system, an estimated time of arrival of the elevator car at a floor; and transmitting the estimated time of arrival to the fire alarm system, the control system being in operative communication with the fire alarm system.

In addition to one or more of the features described above, or as an alternative, further embodiments of the method may include that the fire alarm system further includes an interface device, wherein the control system transmits the estimated time of arrival of the elevator car to the interface device.

In addition to one or more of the features described above, or as an alternative, further embodiments of the method may include that the interface device is at least one of an operational interface of the fire alarm system and a user device.

In addition to one or more of the features described above, or as an alternative, further embodiments of the method may include transmitting, using the control system, to the fire alarm system and the interface device an elevator car status including at least one of an elevator car location within the building, an elevator car load weight status, an elevator car door state, an elevator car direction of travel, and an elevator car speed.

In addition to one or more of the features described above, or as an alternative, further embodiments of the method may include transmitting, using the fire alarm system, to the control system a fire alarm status including at least one of an active evacuation floor, a padding floor, a manual override, an evacuation zone evacuation command, and a total evacuation command.

In addition to one or more of the features described above, or as an alternative, further embodiments of the method may include that the estimated time of arrival of the elevator car is determined in response to at least one of an elevator car location within the building, an elevator car load weight status, an elevator car door state, an elevator car direction of travel, an elevator car speed, and an elevator destination floor.

In addition to one or more of the features described above, or as an alternative, further embodiments of the method may include displaying, using a display, the estimated time of arrival of the elevator car at the floor where the display is located, wherein the display is located on each floor proximate the elevator system and in operative communication with the control system and fire alarm system.

According to another embodiment, a computer program product tangibly embodied on a computer readable medium is provided. The computer program product including instructions that, when executed by a processor, cause the processor to perform operations. The operations including: controlling, using a control system, an elevator system, the elevator system having an elevator car; detecting, using a fire alarm system, a fire within the building, the fire alarm system having an interface device; determining, using the control system, an estimated time of arrival of the elevator car at a floor; and transmitting the estimated time of arrival to the fire alarm system, the control system being in operative communication with the fire alarm system.

In addition to one or more of the features described above, or as an alternative, further embodiments of the computer program may include that the fire alarm system further includes an interface device, wherein the control system transmits the estimated time of arrival of the elevator car to the interface device.

In addition to one or more of the features described above, or as an alternative, further embodiments of the computer program may include that the interface device is at least one of an operational interface of the fire alarm system and a user device.

In addition to one or more of the features described above, or as an alternative, further embodiments of the computer program may include that the operation further include: transmitting, using the control system, to the fire alarm system and the interface device an elevator car status including at least one of an elevator car location within the building, an elevator car load weight status, an elevator car door state, an elevator car direction of travel, and an elevator car speed.

In addition to one or more of the features described above, or as an alternative, further embodiments of the computer program may include that the operations further include: transmitting, using the fire alarm system, to the control system a fire alarm status including at least one of an active evacuation floor, a padding floor, a manual override, an evacuation zone evacuation command, and a total evacuation command.

In addition to one or more of the features described above, or as an alternative, further embodiments of the computer program may include that the estimated time of arrival of the elevator car is determined in response to at least one of an elevator car location within the building, an elevator car load weight status, an elevator car door state, an elevator car direction of travel, an elevator car speed, and an elevator destination floor.

Technical effects of embodiments of the present disclosure include building elevator system having a control system in operative communication with a fire alarm system of the building and the control system is configured to provide an estimated time of arrival of an elevator car at a floor in the building to the fire alarm system.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the disclosure are apparent from the following detailed description taken in conjunction with the accompanying drawings in which like elements are numbered alike in the several FIGURES:

FIG. 1 illustrates a schematic view of an elevator system, in accordance with an embodiment of the disclosure;

FIG. 2 illustrates a schematic view of a building elevator system incorporating the elevator system of FIG. 1, in accordance with an embodiment of the disclosure;

FIG. 3 illustrates a block wiring diagram of the building elevator system of FIG. 2, in accordance with an embodiment of the disclosure; and

FIG. 4 is a flow chart of method of operating the building elevator system of FIG. 2, in accordance with an embodiment of the disclosure.

### DETAILED DESCRIPTION

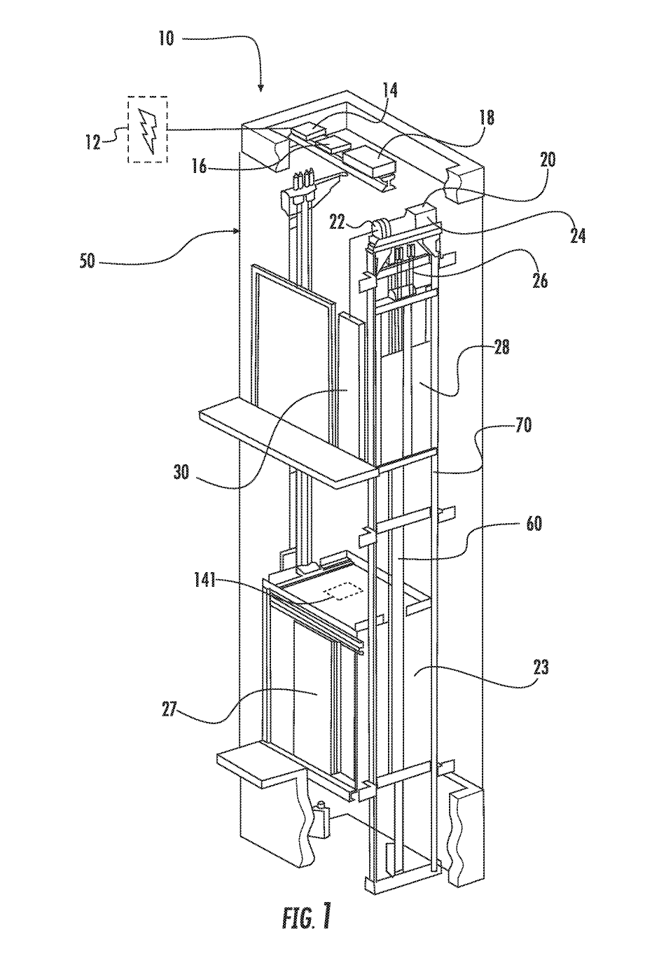

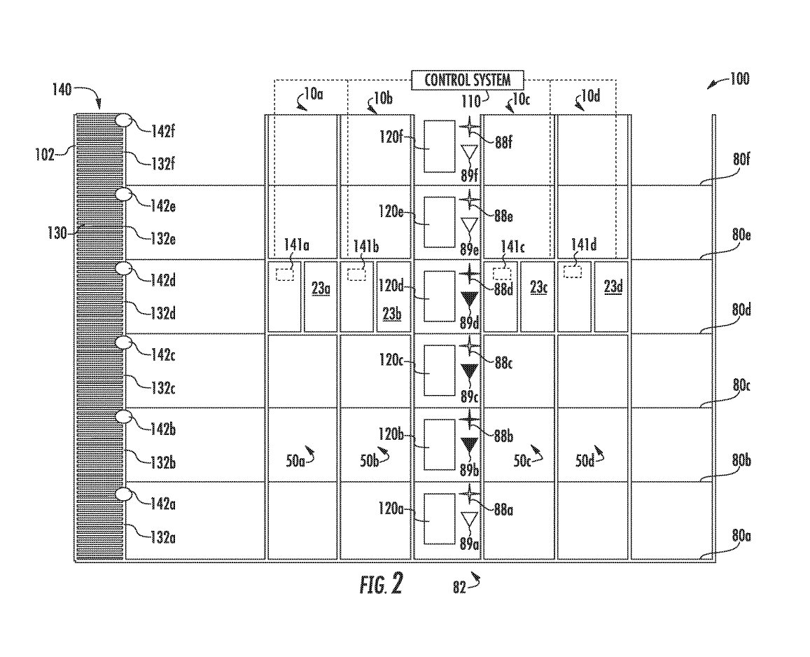

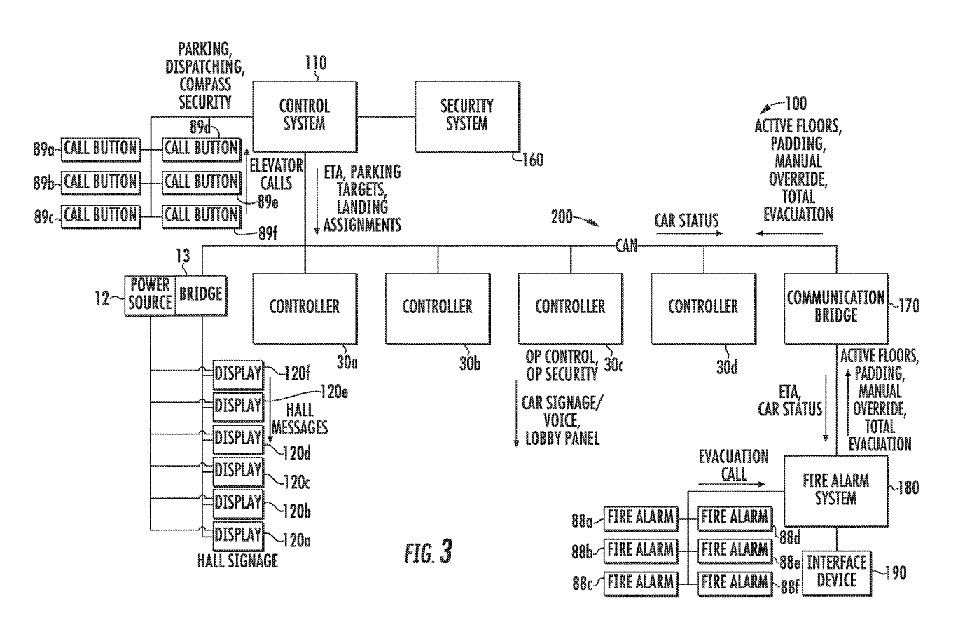

FIG. 1 illustrates a schematic view of an elevator system 10, in accordance with an embodiment of the disclosure. FIG. 2 illustrates a schematic view of a building elevator system 100 incorporating the elevator system 10 of FIG. 1, in accordance with an embodiment of the disclosure. FIG. 3 illustrates a block wiring diagram of the building elevator system 100 of FIG. 2, in accordance with an embodiment of the disclosure. With reference to FIG. 1, the elevator system 10 includes an elevator car 23 configured to move vertically upward and downward within a hoistway 50 along a plurality of car guide rails 60. As seen in FIG. 1, the elevator car 23 includes a door 27 configured to open and close, allowing passengers (ex: occupants of the building) to enter and exit the elevator car 23. The elevator system 10 also includes a counterweight 28 operably connected to the elevator car 23 via a pulley system 26. The counterweight 28 is configured to move vertically upward and downward within the hoistway 50. The counterweight 28 moves in a direction generally opposite the movement of the elevator car 23, as is known in conventional elevator assemblies. Movement of the counterweight 28 is guided by counterweight guide rails 70 mounted within the hoistway 50.

The elevator system 10 also includes a power source 12. The power is provided from the power source 12 to a switch panel 14, which may include circuit breakers, meters, etc. From the switch panel 14, the power may be provided directly to the drive unit 20 through the controller 30 or to an internal power source charger 16, which converts AC power to direct current (DC) power to charge an internal power source 18 that requires charging. For instance, an internal power source 18 that requires charging may be a battery, capacitor, or any other type of power storage device known to one of ordinary skill in the art. Alternatively, the internal power source 18 may not require charging from the external power source 12 and may be a device such as, for example a gas powered generator, solar cells, hydroelectric generator, wind turbine generator or similar power generation device. The internal power source 18 may power various components of the elevator system 10 when an external power source is unavailable. The drive unit 20 drives a machine 22 to impart motion to the elevator car 23 via a traction sheave of the machine 22. The machine 22 also includes a brake 24 that can be activated to stop the machine 22 and elevator car 23. As will be appreciated by those of skill in the art, FIG. 1 depicts a machine room-less elevator system 10, however the embodiments disclosed herein may be incorporated with other elevator systems that are not machine room-less or that include any other known elevator configuration. In addition, elevator systems having more than one independently operating elevator car in each elevator car shaft and/or ropeless elevator systems may also be used. In one embodiment, the elevator car 23 may have two or more compartments.

The controller 30 is responsible for controlling the operation of the elevator system 10. The controller 30 may also determine a mode (motoring, regenerative, near balance) of the elevator car 23. The controller 30 may use the car direction and the weight distribution between the elevator car 23 and the counterweight 28 to determine the mode of the elevator car 23. The controller 30 may adjust the velocity of the elevator car 23 to reach a target floor. The controller 30 may include a processor and an associated memory. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

The elevator system 10 may also include a sensor system 141 configured to detect a remaining capacity in a particular elevator car 23. The remaining capacity allows the controller 30 to determine how much space is left in the elevator car 23. For instance, if the remaining capacity is equal to about zero there is no space left in the elevator car 23 to accept more passengers, whereas if the remaining capacity is greater than zero there may be space to accept more passengers in the elevator car 23. The sensor system 141 is in operative communication with the controller 30. The sensor system 141 may use a variety of sensing mechanisms such as, for example, a visual detection device, a weight detection device, a laser detection device, a door reversal monitoring device, a thermal image detection device, and a depth detection device. The visual detection device may be a camera that utilizes visual recognition to identify individual passengers and objects in the elevator car 23 and then determine remaining capacity. The weight detection device may be a scale to sense the amount of weight in an elevator car 23 and then determine the remaining capacity from the weight sensed. The laser detection device may detect how many passengers walk through a laser beam to determine the remaining capacity in the elevator car 23. Similarly, a door reversal monitoring device also detects passengers entering the car so as not to close the elevator door on a passenger and thus may be used to determine the remaining capacity. The thermal detection device may be an infrared or other heat sensing camera that utilizes detected temperature to identify individual passengers and objects in the elevator car 23 and then determine remaining capacity. The depth detection device may be a 2-D, 3-D or other depth/distance detecting camera that utilizes detected distance to an object and/or passenger to determine remaining capacity. As may be appreciated by one of skill in the art, in addition to the stated methods, additional methods may exist to sense remaining capacity and one or any combination of these methods may be used to determine remaining capacity in the elevator car 23.

FIG. 2 shows a building elevator system 100 incorporating a multiple elevator systems 10a-10d organized in an elevator bank 82 within a building 102. As may be appreciated by one of skill in the art, FIG. 2 only shows one elevator bank 82 for simplicity but more than one elevator banks may exist in the building 102. Each elevator system 10a-10d has an elevator car 23a-23d in an elevator hoistway 50a-50d. The building elevator system 100 is controlled by a system controller 110. The control system 110 is operably connected to the individual controller 30 (see FIG. 1) of each elevator system 10a-10d. In one embodiment, each elevator system 10a-10d may share a single controller 30. The control system 110 is configured to the control and coordinate operation of multiple elevator systems 10a-10d. The control system 110 may be an electronic controller including a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium

The building 102 includes multiple floors 80a-80f, each having an elevator call button 89a-89f and an evacuation alarm 88a-88f. The elevator call button 89a-89f sends an elevator call to the control system 110. The elevator call button 89a-89f may be a push button and/or a touch screen and may be activated manually or automatically. For example, the elevator call button 89a-89f may be activated by a building occupant pushing the elevator call button 89a-89f. The elevator call button 89a-89f may also be activated voice recognition or a passenger detection mechanism in the hallway, such as, for example a weight sensing device, a visual recognition device, and a laser detection device. The evacuation alarm 88a-88f may be activated or deactivated either manually or automatically through a fire alarm system 180 (FIG. 3). If the evacuation alarm 88a-88f is activated, an evacuation call is sent to the control system 110 indicating the respective floor 80a-80f where the evacuation alarm 88a-88f was activated. In the example of FIG. 2, an evacuation alarm 88d is activated first on floor 80d and an evacuation alarm 88b is later activated on floor 80b. The evacuation alarm 88a, 88, 88e, 88f is not activated on floors 80a, 80c, 80e, and 80f. The first floor to activate an evacuation alarm may be known as the first evacuation floor. In the example of FIG. 2, the first evacuation floor is floor 80d. The second evacuation floor to activate an evacuation alarm may be known as the second evacuation floor and so on.

The first evacuation floor may be surrounded by padding floors, which are floors that are considered at increased risk due to their proximity to the evacuation floor and thus should also be evacuated. In the example of FIG. 2, the padding floors for the first evacuation floor are floors 80b, 80c, 80e, and 80f. The padding floors may include floors that are a selected number of floors away from the first evacuation floor. In one embodiment, the padding floors may include any number of floors on either side of an evacuation floor. For example, in one embodiment, the padding floors may include the floor immediately below the evacuation floor and the three floors immediately above the evacuation floor. In another example, in one embodiment, the padding floors may include the two floors immediately below the evacuation floor and the two floors immediately above the evacuation floor. The first evacuation floor and the padding floors make up an evacuation zone. In the example of FIG. 2, the evacuation zone is composed of floors 80b-80f.

In an embodiment, the floors 80b-80f that compose the evacuation zone may be determined automatically by the fire alarm system 180 or entered manually into the fire alarm system 180 through an interface device 190 (see FIG. 3). The interface device 190 may be at least one of an operational interface of the fire alarm system 180 and a user device. In one example an operation interface, is a device directly connected to the fire alarm system 180 within the building 102 where rescue personnel may input and receive information to and from the fire alarm system 180, such as, for example a fire control panel. A user device may be a mobile device, such as, for example a laptop, tablet, smart watch, or cellular phone. The rescue personnel may carry the user device with them and connect to the fire alarm system 180 through a wired and/or wireless connection. The evacuation priority of floors may be determined automatically by the fire alarm system 180 or by a manual input through the interface device 190. In an example, the evacuation priority may prioritize the first evacuation floor for evacuation, the evacuation zone for evacuation and/or higher floors for evacuation over lower floors.

In one embodiment, there may be more than one evacuation floor. For example, after the first evacuation floor activates an evacuation alarm, a second evacuation floor may also activate an evacuation alarm. In the example of FIG. 2, the second evacuation floor is floor 80b. In one embodiment, there may be any number of evacuation floors. Evacuation floors may be evacuated in the order that the evacuation call is received. Padding floors of the first evacuation floor may be evacuated before the second evacuation floor. In one embodiment, all evacuation floors may be evacuated first, followed by padding floors associated with each evacuation floor in the order in which the corresponding evacuation call was placed. Although in the embodiment of FIG. 2 the second evacuation floor is contiguous to the padding floors of the first evacuation floor, the second evacuation floor and any subsequent evacuation floors may be located anywhere within the building. The building also includes a discharge floor, which is a floor where occupants can evacuate the building 102. For example, in one embodiment the discharge floor may be a ground floor. In the example of FIG. 2, the discharge floor is floor 80a. The building may also include a stairwell 130 as seen in FIG. 2.

The control system 110 may be configured to determine how many passengers are on a particular floor 80a-80f. The control system 110 may determine how many passengers are on a particular floor 80a-80f using an executable algorithm and/or a look up table that may be stored within the memory of the control system 110. The look up table may contain predicted number for how many passengers are on each floor 80a-80f on a particular date at a particular time. For example, the predicted number of passenger may be more for a day during the work week than a day on the weekend. The control system 110 may also determine how many passengers are on a particular floor 80a-80f using a building integrated personnel sensing system 140 composed a plurality of sensors throughout the building 102 configured to detect a number of passengers on each floor 80a-80f. The building integrated personnel sensing system 140 may count the number of passengers entering and exiting each floor 80a-80f using stairwell door sensors 142a-142f and also the sensor systems 141a-141d in each elevator car 23a-23d.

The stairwell door sensor 142a-142f counts the number of passengers entering and exiting the respective stairwell door 132a-132f. The stairwell door sensor 142a-142f may use a variety of sensing mechanisms such as, for example, a visual detection device, a weight detection device, a laser detection device, a thermal image detection device, and a depth detection device. The visual detection device may be a camera that utilizes visual recognition to identify and count individual passengers entering and exiting a particular floor 80a-80f from the stairwell 130. The weight detection device may be a scale to sense the amount of weight in an area proximate the stairwell door 132a-132f and then determine the number of passengers entering and exiting a particular floor 80a-80f from the weight sensed. The laser detection device may detect how many passengers walk through a laser beam located proximate the stairwell door 132a-132f to determine the number of passengers entering and exiting a floor 80a-80f. The thermal detection device may be an infrared or other heat sensing camera that utilizes detected temperature to identify how many passengers are located proximate the stairwell door 132a-132f to determine the number of passengers entering and exiting a floor 80a-80f. The depth detection device may be a 2-D, 3-D or other depth/distance detecting camera that utilizes detected distance to a passenger to determine how many passengers are located proximate the stairwell door 132a-132f to determine the number of passengers entering and exiting a floor 80a-80f. The stairwell door sensor 142a-142f interacts with the sensor systems 141a, 141b to determine the number of passengers on each floor 80a-80f. As may be appreciated by one of skill in the art, in addition to the stated methods, additional methods may exist to sense passengers and one or any combination of these methods may be used to determine the number of passengers entering and exiting a floor 80a-80f.

Advantageously, by tracking the number of passengers entering or exiting a floor 80a-80f, when an evacuation call is received from a first evacuation floor, the controller 30 could quickly identify how many passengers are on each floors 80a-80f and provide this information to rescue personnel via the interface device 190.

As seen in FIG. 2, each elevator bank 92, 94 includes a display 120a-120f on each floor 80a-80f. The displays 120a-120f may be a device for conveying information, such as, for example, a television screen or computer monitor. The displays 120a-120f are located proximate to the elevator systems 10a-10d on each floor 80a-80f. In one embodiment, there may be one display 120a-120f per elevator bank 82 on each floor 80a-80f, as seen in FIG. 2. In another embodiment, there may be one display 120a-120f per elevator system 10a-10f on each floor 80a-80f. The control system 110 may determine the evacuation information to display on each display 120a-120f. In an embodiment, the displays 120a-120f each display an estimated time of arrival of the elevator car 26 at the floor 80a-80f where the display 120a-120f is located. In another embodiment, the estimated time of arrival may be determined by the control system 110 in response to at least one of an elevator car location within the building 102, an elevator car load weight status, an elevator car door state, an elevator car direction of travel, an elevator car speed, and an elevator destination floor. The elevator car load weight status is the weight that the elevator car 23a-23d is currently carrying, which may be determined by the sensor system 141a-141d, as discussed above. Moreover, the elevator car door state is whether the door 27 is open or closed, which may also be determined by the sensor system 141a-141d or more specifically a door reversal device of the sensor system 141a-141d, as discussed above. The elevator destination floor is the floor 80a-80f where the display is located. In one example, if the display 120c is located on floor 80c then the destination floor is 80c and the display 120 will display the estimated time of arrival of the next elevator car 23a-23d to floor 80c.

As seen in FIG. 3, components of the building elevator system may be operably connected to each other through a campus area network (CAN) 200. The control system 110 is connected to and in operative communication with the fire alarm system 180. As seen in FIG. 3, the fire alarm system 180 is connected to each fire alarm 88a-88f. The connection between the control system 110 and the fire alarm system 180 may be made through the CAN 200 and a communication bridge 170. The communication bridge 170 may use a communication protocol, such as, for example MODBUS, BACNet, and Metasys. The control system 110 may transmit to the fire alarm system 180 and the interface device 190 an elevator car status including at least one of an elevator car location within the building, an elevator car load weight status, an elevator car door state, an elevator car direction of travel, and an elevator car speed. The elevator car load weight status may be how much weight is currently in the elevator car 23. The elevator car door state may be whether or not the door 27 of the elevator car 23 is open or closed.

The fire alarm system 180 may transmit to the control system 110 a fire alarm status including at least one of an active evacuation floor, a padding floor, a manual override, an evacuation zone evacuation command, and a total evacuation command. As mentioned earlier, the fire alarm system 180 and/or rescue personnel may determine the active evacuation floor, the padding floor, an evacuation zone evacuation command, and a total evacuation command. There may be two commands to give the control system 110 that determine how the evacuation is carried out including but not limited to the evacuation zone evacuation command and the total evacuation command. The evacuation zone evacuation command would indicate to the control system 110 to first determine an evacuation zone including the evacuation floor and padding floors surrounding the evacuation zone, then evacuate the evacuation zone. The total evacuation command would be to evacuate the entire building from top to bottom. Rescue personnel may also input a manual override through the interface device 190 to override an action by the fire alarm system 180. A manual override may be any manual command to control the elevator car 23 in a particular manor. As seen in FIG. 3, controllers 30a-30d for each elevator car 23a-23d are connected to the CAN 200, as well as call buttons 89a-89f for each floor 80a-80f. A security system 160 may also be connected to the CAN 200. Also, connected to the CAN 200 are the displays 120a-120f for each floor 80a-80f. The displays 120a-120f may be connected through a bridge 13 or directly connected to the controllers 23a-23d.

Advantageously by connecting the fire alarm system 180 to the control system 110, an abundance of information may be shared directly with rescue personnel who may subsequently use information, such as elevator estimated time of arrivals, to more efficiently carry out a building evacuation.

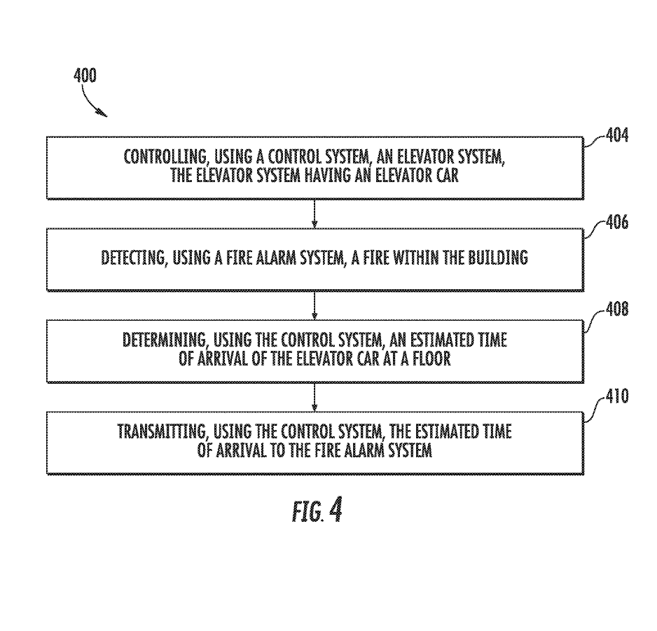

Referring now to FIG. 4, while referencing components of FIGS. 1-3. FIG. 4 shows a flow chart of a method 400 of operating the building elevator system 100 of FIG. 2, in accordance with an embodiment of the disclosure. At block 404, the control system 110 controls the elevator system 10, which has an elevator car 23 as described above. At block 406, the fire alarm system 180 detects a fire within the building 102. The fire alarm system 180 may include an interface device 190, as mentioned above. At block 408, the control system 110 determines an estimated time of arrival of the elevator car 23 at a floor 80a-80f. At block 410, the control system 110 transmits the estimated time of arrival to the fire alarm system 180. The control system 110 may also transmit the estimated time of arrival to the interface device 190.

The method 400 may also include that the control system 110 transmits to the fire alarm system 180 an elevator car status including at least one of an elevator car location within the building, an elevator car load weight status, an elevator car door state, an elevator car direction of travel, and an elevator car speed. The method 400 may further include that the fire alarm system 180 transmits to the control system 110 a fire alarm status including at least one of an active evacuation floor, a padding floor, a manual override, an evacuation zone evacuation command, and a total evacuation command. The method 400 may still further include that the display 120a-120f displays the estimated time of arrival of the elevator car 23a-23d at the floor 80a-80f where the display 120a-120f is located. As mentioned above, the display 120a-120f is located on each floor 80a-80f proximate the elevator system 10a-10d and is in operative communication with the control system 110 and fire alarm system 180.

While the above description has described the flow process of FIG. 4 in a particular order, it should be appreciated that unless otherwise specifically required in the attached claims that the ordering of the steps may be varied.

As described above, embodiments can be in the form of processor-implemented processes and devices for practicing those processes, such as processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The terminology used herein is for the purpose of describing particular embodiments only and is not intended to be limiting. While the description has been presented for purposes of illustration and description, it is not intended to be exhaustive or limited to embodiments in the form disclosed. Many modifications, variations, alterations, substitutions or equivalent arrangement not hereto described will be apparent to those of ordinary skill in the art without departing from the scope of the disclosure. Additionally, while the various embodiments have been described, it is to be understood that aspects may include only some of the described embodiments. Accordingly, the disclosure is not to be seen as limited by the foregoing description, but is only limited by the scope of the appended claims.

1. A building elevator system comprising:
a building having multiple floors;
an elevator system within the building, the elevator system having an elevator car; a control system configured to control the elevator system, the control system determines an estimated time of arrival of the elevator car at a floor in response to at least one of an elevator car location within the building, an elevator car load weight status, an elevator car door state, an elevator car direction of travel, an elevator car speed, and an elevator destination floor; and
a fire alarm system within the building and in operative communication with the control system;
wherein the control system transmits the estimated time of arrival of the elevator car to the fire alarm system.

2. The building elevator system of claim 1, wherein:
the fire alarm system further comprises an interface device, wherein the control system transmits the estimated time of arrival of the elevator car to the interface device.

3. The building elevator system of claim 2, wherein:
the interface device is at least one of an operational interface of the fire alarm system and a user device.

4. The building elevator system of claim 2, wherein:
the control system transmits to the fire alarm system and the interface device an elevator car status including at least one of an elevator car location within the building, an elevator car load weight status, an elevator car door state, an elevator
car direction of travel, and an elevator car speed.

5. The building elevator system of claim 1, wherein:
the fire alarm system transmits to the control system a fire alarm status including at least one of an active evacuation floor, a padding floor, a manual override, an evacuation zone evacuation command, and a total evacuation command.

6. (canceled)

7. The building elevator system of claim 1, further comprising:
a display located on each floor proximate the elevator system and in operative communication with the control system and fire alarm system, wherein the display is configured to display the estimated time of arrival of the elevator car at the floor where the display is located.

8. A method of operating a building elevator system for a building having multiple floors, the method comprising:
controlling, using a control system, an elevator system, the elevator system having an elevator car;
detecting, using a fire alarm system, a fire within the building;
determining, using the control system, an estimated time of arrival of the elevator car at a floor in response to at least one of an elevator car location within the building, an elevator car load weight status, an elevator car door state, an elevator car direction of travel, an elevator car speed, and an elevator destination floor; and
transmitting the estimated time of arrival to the fire alarm system, the control system being in operative communication with the fire alarm system.

9. The method of claim 8, wherein:
the fire alarm system further comprises an interface device, wherein the control system transmits the estimated time of arrival of the elevator car to the interface device.

10. The method of claim 9, wherein:
the interface device is at least one of an operational interface of the fire alarm system and a user device.

11. The method of claim 9, further comprising:
transmitting, using the control system, to the fire alarm system and the interface device an elevator car status including at least one of an elevator car location within the building, an elevator car load weight status, an elevator car door state, an elevator car direction of travel, and an elevator car speed.

12. The method of claim 8, further comprising:
transmitting, using the fire alarm system, to the control system a fire alarm status including at least one of an active evacuation floor, a padding floor, a manual override, an evacuation zone evacuation command, and a total evacuation command.

13. (canceled)

14. The method of claim 8, further comprising:
displaying, using a display, the estimated time of arrival of the elevator car at the floor where the display is located, wherein the display is located on each floor proximate the elevator system and in operative communication with the control system and fire alarm system.

15. A computer program product tangibly embodied on a computer readable medium, the computer program product including instructions that, when executed by a processor, cause the processor to perform operations comprising:
controlling, using a control system, an elevator system, the elevator system having an elevator car;
detecting, using a fire alarm system, a fire within a building, the fire alarm system having an interface device;
determining, using the control system, an estimated time of arrival of the elevator car at a floor in response to at least one of an elevator car location within the building, an elevator car load weight status, an elevator car door state, an elevator car direction of travel, an elevator car speed, and an elevator destination floor; and
transmitting the estimated time of arrival to the fire alarm system, the control system being in operative communication with the fire alarm system.

16. The computer program of claim 15, wherein:
the fire alarm system further comprises an interface device, wherein the control system transmits the estimated time of arrival of the elevator car to the interface device.

17. The computer program of claim 16, wherein:
the interface device is at least one of an operational interface of the fire alarm system and a user device.

18. The computer program of claim 16, wherein the operations further comprise:
transmitting, using the control system, to the fire alarm system and the interface device an elevator car status including at least one of an elevator car location within the building, an elevator car load weight status, an elevator car door state, an elevator car direction of travel, and an elevator car speed.

19. The computer program of claim 15, wherein the operations further comprise:
transmitting, using the fire alarm system, to the control system a fire alarm status including at least one of an active evacuation floor, a padding floor, a manual override, an evacuation zone evacuation command, and a total evacuation command.

20. (canceled)
